(19) United States
(12) Patent Application Publication
(10) Pub. No.: US 2019/0191725 A1
(43) Pub. Date: Jun. 27, 2019

(54) Method of Making Seitan Snack Food Products

(71) Applicant: Frito-Lay North America, Inc., Plano, TX (US)

(72) Inventors: Charlene Gladden, McKinney, TX (US); Chien-Seng Hwang, Frisco, TX (US); Thomas A. Trezza, Plano, TX (US); Yi Zhu, Plano, TX (US)

(21) Appl. No.: 15/849,952

(22) Filed: Dec. 21, 2017

(51) Int. Cl. A21D 13/40; A21D 6/00; A23L 5/10; A23L 29/00

(52) U.S. Cl. CPC A21D 13/40; A21D 6/001; A23V 2002/00; A23L 5/10; A23L 29/00; A21D 6/003

(57) ABSTRACT

A spongy dough comprising a high amount of wheat gluten is formed into a loaf and subjected to a series of cooling and cooking steps including chilling, boiling, cooling, frying, and drying to produce imitation bacon snack food products with a low water activity of less than 0.85.

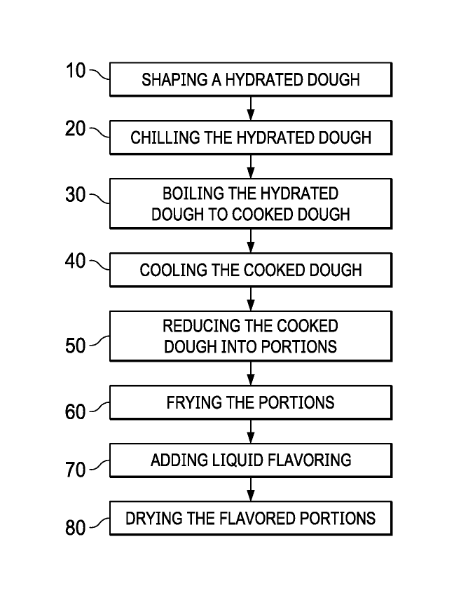

### BACKGROUND OF THE INVENTION

### Technical Field

A food processing method is described herein, and more particularly a method for producing an imitation-bacon snack food product.

### Description of Related Art

A variety of food products attempt to mimic the taste and texture of bacon products. Seitan is used as a meat alternative high in protein, and can be made from either whole wheat flour or vital wheat gluten. There remains a need for a vegetarian snack food product with a useful shelf life. Such a snack food should remain stable without relying on refrigerated storage, while closely mimicking the flavor and texture of popular pork bacon products.

### SUMMARY OF THE INVENTION

Below is a simplified summary of this disclosure meant to provide a basic understanding of the method and product described herein. This is not an exhaustive overview and is not intended to identify key or critical elements or to delineate the scope of the description. Its sole purpose is to present some concepts in a simplified form as a prelude to the more detailed description below.

A method of forming a snack food product comprising the steps of: shaping a hydrated dough into a shaped dough, the hydrated dough comprising wheat gluten; chilling the shaped dough to form a chilled dough; boiling the chilled dough for between about 1 to about 2 hours, thereby producing a boiled, shaped dough; cooling the boiled, shaped dough at temperatures ranging from about 32° F. to about 40° F. for at least 1 hour; reducing the size of the boiled, shaped dough into a plurality of portions; frying the portions, thereby producing fried portions of less than 2% moisture content; adding a liquid flavoring solution to the fried portions to form flavored portions; and drying the flavored portions to a water activity level of less than about 0.85.

Other aspects, embodiments and features of the invention will become apparent in the following written detailed description and accompanying drawings.

### BRIEF DESCRIPTION OF THE DRAWINGS

The novel features believed characteristic of the invention are set forth in the appended claims. The invention itself, and further objectives and advantages thereof, will be best understood by reference to the following detailed description when read in conjunction with the accompanying drawing, wherein the:

FIGURE depicts a flow chart of one embodiment for making seitan snack food products as described herein.

### DETAILED DESCRIPTION OF THE INVENTION

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase.

When used in the appended claims, in original and amended form, the term “comprising” is intended to be inclusive or open-ended and does not exclude any additional, unrecited element, method, step or material. Thus, the terms “including,” “comprising,” “having,” and variations thereof mean “including but not limited to,” unless expressly specified otherwise. The term “consisting of” excludes any element, step or material other than those specified in the claim. All numerical ranges included herein are inclusive of both end points and all numerical values that lie between both endpoints.

Referring now to the FIGURE, the method for producing seitan snack food products generally comprises the steps of: shaping a hydrated dough 10 comprising wheat gluten, chilling the dough 20, boiling the dough 30, cooling the dough 40, sizing the dough 50, frying the dough 60, adding a liquid flavoring solution to the dough 70, and drying the dough 80 to a water activity level of less than about 0.85. In one embodiment, the method for making seitan snack food products comprises the steps of: boiling a hydrated, shaped dough comprising wheat gluten to form a boiled dough, reducing the size of the boiled dough, frying the boiled dough, thereby forming a cooked seitan base of less than about 2% moisture content; and drying the cooked seitan base to form seitan snack food products with a water activity of less than about 0.85. As used herein, a “snack food product” refers to a ready-to-eat food product, requiring no further cooking. The produced snack food is stable and safe to store at ambient conditions; thus, the low water activity allows for the snack food to avoid the need for refrigeration.

The hydrated dough 10 is formed from dry components combined with an aqueous solution comprising water. Thus, the hydrated dough comprises dry components and an aqueous solution at a ratio of at least about 50:50. In some embodiments, the ratio of dry components to the aqueous solution ranges from between about 50:50 to about 50:60. In some embodiments, the ratio of dry components to the aqueous solution ranges from between about 50:50 to about 50:55. Dry components include without limitation flour, granules, flakes, powders, clusters, agglomerated particles, and any combination thereof, for example. In some embodiments, the aqueous solution comprises water. In some embodiments, the aqueous solution comprises between about 60% to about 99% water. In some embodiments, the aqueous solution consists of water. In some embodiments, the amount of dry components and the amount of water should be substantially equal. In some embodiments, the amount of water used should slightly exceed (i.e., by up to 10%) the amount of dry components used such that the water provides for a consistently spongy texture throughout the dough. As used herein, “spongy” refers to a compressible, elastic, and pliable dough texture that is neither firm, tight, nor a loose batter that can be poured or dropped. Instead, the hydrated dough should resemble a soft, porous substance similar to a sponge. Thus, the hydrated dough comprises a spongy texture and can also be referred to as a spongy dough. In some embodiments, the method described herein may comprise, prior to shaping a hydrated dough, the step of forming the hydrating dough by combining the dry components and aqueous solution as described herein.

Generally, the major component of the total dry components used to form the hydrated dough is gluten or wheat gluten. As used herein, “wheat gluten” refers to a protein extract of wheat flour. Wheat gluten is prepared by removing a significant portion of the starch, fibers, pentosans and water-soluble materials from wheat flour. This is generally accomplished by water washing. The washed gluten is then dehydrated to form a powder. However, one skilled in the art will recognize that gluten is the protein found and/or derived from wheat, barley, rye, oats, and related species and/or hybrids of wheat, barley, rye, and oat. Consequently, in some embodiments, gluten refers to gluten protein from any available source and to mixtures of gluten protein from different sources. In certain embodiments, the hydrated dough may be described as a gluten-based dough capable of forming a seitan base.

Wheat gluten is available in a range of protein contents, and can range in protein content from above 70%. In some embodiments, the wheat gluten comprises between about 50% to about 90% protein. In some embodiments, the wheat gluten comprises about 60% to about 80% protein. In some embodiments, the wheat gluten comprises about 75% to about 80% protein. In some embodiments, the wheat gluten is a vital wheat gluten. Vital wheat gluten is defined as a viscoelastic gluten that can be stretched without tearing when hydrated.

Suitable dry components should comprise at least about 50% wheat gluten, based on the weight of the dry components. In some embodiments, the dry components comprise at least about 55% wheat gluten, based on the weight of the dry components. In some embodiments, the dry components comprise at least about 60% wheat gluten, based on the weight of the dry components. In some embodiments, the dry components comprise at least about 70% wheat gluten, based on the weight of the dry components. In some embodiments, the dry components comprise between about 50% to about 85% wheat gluten, based on the weight of the dry components. In some embodiments, the dry components comprise between about 50% to about 75% wheat gluten. In some embodiments, the dry components comprise between about 50% to about 65% wheat gluten. The wheat gluten should be in any dry form known in the art including without limitation flour, granules, flakes, clusters, powder, or any combination of such dry forms, for example.

In some embodiments, the dry components comprise barley. Barley may be present, in certain embodiments, as the secondary component, or the second largest percentage making up the total of the dry components. In one embodiment, the dry components comprise no more than about 25% barley, based on the total weight of the dry components. In one embodiment, the dry components comprise between about 12% to about 25% barley, based on the total weight of the dry components. In one embodiment, the dry components comprise between about 15% to about 22% barley, based on the total weight of the dry components. In one embodiment, the dry components comprise between about 16.5% to about 20% barley, based on the total weight of the dry components.

In some embodiments, the dry components comprise nutritional (i.e., deactivated) yeast. In some embodiments, the dry components comprise between about 3.5% to about 7% deactivated yeast, based on the total weight of the dry components. In some embodiments, the dry components comprise about 3.5% deactivated yeast, based on the weight of the dry components. In some embodiments, the dry components comprise about 4.5% deactivated yeast, based on the weight of the dry components. In some embodiments, the dry components comprise about 5.5% deactivated yeast, based on the weight of the dry components. In some embodiments, the dry components comprise about 6.0% deactivated yeast, based on the weight of the dry components. In some embodiments, the dry components comprise about 6.5% deactivated yeast, based on the weight of the dry components.

The dry components should further comprise an amount of seasoning in some embodiments. As used herein, a seasoning is any component that provides a desirable, agreeable taste to the snack food product produced herein. In some embodiments, the dry components comprise between about 3.5% to about 7% seasoning, based on the total weight of the dry components. In some embodiments, the dry components comprise about 3.5% seasoning. In some embodiments, the dry components comprise about 4.5% seasoning, based on the weight of the dry components. In some embodiments, the dry components comprise about 5.5% seasoning, based on the weight of the dry components. In some embodiments, the dry components comprise about 6.0% seasoning, based on the weight of the dry components. In some embodiments, the dry components comprise about 6.5% seasoning, based on the weight of the dry components.

In one embodiment, the total amount of yeast and seasoning may comprise between about 8% to about 15%, based on the weight of the dry components. In some embodiments, the dry components comprise substantially equal amounts of nutritional yeast and seasoning. In some embodiments, the dry components comprise gluten, barley, deactivated yeast, and seasoning. In some embodiments, the yeast and the seasoning are present in substantially equal parts.

Other minor (i.e., less than 20%) suitable dry components for combination with the wheat gluten to form the dough described herein include without limitation legumes and pulses. By way of example, minor suitable dry components include without limitation chickpea flour, pea protein, oat flour, rice protein, soy protein, other legumes or pulses in any form, and any combination thereof. In some embodiments, the dry components, formed dough, and final product are free of buckwheat. In some embodiments, the dry components, formed dough, and final product are free of beans in any form. In some embodiments, the dry components, formed dough, and final product are free of adzuki beans. In one embodiment, the dry components consist of vital wheat gluten, barley, deactivated yeast, and seasoning. One skilled in the art, armed with this disclosure, will recognize that any of the dry components discussed herein may also be introduced in liquid form so long as component to water ratio is accounted for such that the dough achieves the spongy texture for the hydrated dough as described above.

In some embodiments, dry components may first be combined and mixed followed by addition of the aqueous solution to form a suitable hydrated dough for shaping 10. Once the aqueous solution is added to the dry components, the combined components are kneaded until the spongy texture of the hydrated dough is attained. In one embodiment, the hydrated dough comprises a moisture content of between about 50% to about 60%. The percentages of dry components and water are substantially equal. As used herein, “substantially equal” is meant to refer to near equivalent amounts of dry components and water, with a variation of no more than 10% between the dry components and water. In some embodiments, the term “substantially” refers to a difference of no more than 5% between the dry components and water. In some embodiments, the hydrated dough comprises more water than dry components. Having formed or obtained a hydrated dough, the hydrated dough comprises at least about 25% wheat gluten, based on total weight of the dough.

With reference back to the FIGURE, the dough is shaped 10 into any form desired for manipulation. In one embodiment, the dough is shaped into a loaf with a thickness of less than about 5 cm. The shaped dough should comprise the same consistent sponginess throughout as it had prior to shaping. During test runs, the hydrated dough was shaped into a thin loaf comprising a thickness of about 1 cm. Following shaping 10, the dough is chilled 20. In one embodiment, the dough is refrigerated for at least about 30 minutes at a temperature of greater than about 32° F. and less than about 40° F. Optionally, the dough may be wrapped prior to refrigeration to prevent contamination. The chilling 20 should take place for no more than between about 3 to about 4 days.

Following chilling 20, the chilled dough is generally subjected to three cooking steps. In a first cooking step, the method described herein comprises a boiling step 30 for between about 1 to about 2 hours. In one embodiment, the boiling step 30 is performed for about 1.5 hours. The boiling step thus comprises the boiling of a hydrated, shaped dough comprising gluten to form a boiled dough. In some embodiments, the hydrated, shaped dough is also chilled prior to the boiling step. In one embodiment, the boiling step 40 is performed at a temperature of between about 180° F. and about 215° F. In one embodiment, the boiling step 40 is performed in salted water. Salted water refers herein to an aqueous solution of sodium chloride. The boiling step 30 produces a fully cooked and edible dough based product but is not yet a shelf stable snack food product. Having boiled the dough, the shaped dough should be able to maintain the shape into which it was formed. After boiling 30, the cooked dough is cooled 40 at a temperature ranging from about 32° F. to about 40° F. for at least about 1 hour. In some embodiments, the cooling 40 takes place for at least about 2 hours. In some embodiments, the cooling step 40 comprises submerging the cooked dough in ice water. In some embodiments, the cooling step 40 comprises a combination of ice water bath and refrigeration. In some embodiments, the cooling step 40 comprises submerging the dough in ice water for at least about 30 minutes. Following the ice water bath, the dough may then be stored at refrigerated temperatures for the remaining portion of time. In some embodiments, the cooling step 40 comprises storing the dough in refrigerated temperatures for at least about 6 hours. The cooling step 40 may consist of refrigeration in some embodiments. In some embodiments, the cooling step 40 consists of a combination of submerging in ice water followed by refrigeration. In some embodiments, the cooling step 40 comprises submerging in ice water for a minimum of 30 minutes, with refrigeration for a minimum of 30 minutes to allow for ease in cutting the cooled cooked dough.

After cooling 40, the dough may be subject to any number of reducing steps 50 to produce a plurality of portions. In some embodiments, the reducing step 50 may be optional depending on the desired sizing of the end product and the manipulation in the shaping step 10. During test runs, the reducing step 50 comprised slicing the loaf. In some embodiments, the reducing step comprises slicing a boiled dough loaf into elongated slices. In some embodiments, the loaf may be cut into a plurality of elongated slices. In some embodiments, each slice comprises a thickness of less than about 1 cm. In some embodiments, the elongated slices may comprise a thickness of about 2 mm. Once the desired sizing is achieved, the plurality of slices is subjected to the second cooking step, frying 60 the sized portions to produce fried portions of a moisture content of less than about 2%. In some embodiments, the frying step 60 is performed at a temperature of between about 325° F. to about 375° F. In some embodiments, the frying step is performed for between about 1 minute to about 1.5 minutes. Frying the boiled dough forms a cooked seitan base of less than about 2% moisture content.

Following frying 60, fried portions are next subjected to a step of adding a liquid flavoring solution 70 to at least some portion of the fried slices to form flavored portions. The adding step 70 should be performed immediately after frying while the portions remain hot. The adding step 70 may comprise brushing, spraying, immersing, and any combination thereof to the cooked seitan base. The liquid flavoring solution, in some embodiments, complements the flavor of the base cooked dough portions to further emulate a desirable meat bacon flavor.

Following the adding step 70, the flavored portions are finally subjected to the third cooking step: drying 80 to form seitan snack food products with a low water activity level. Drying 80 should generally be performed until a water activity of less than about 0.85 is attained. In one embodiment, the drying step 90 is performed for about 5 minutes at temperatures of between about 200° F. to about 250° F. In some embodiments, the final snack food product comprises the aforementioned water activity level and a moisture content less than about 25%. In some embodiments, the final snack food product comprises the aforementioned water activity level and a moisture content of between about 15% to about 20%. Suitable drying may be performed by any means known in the art, for example, by using any number of ovens to attain the water activity level. For example, one or more convection ovens, drying ovens, dehydrating ovens and any combination thereof may be used. Methods described herein are free of pasteurization and free of vacuum sealing. Resulting snack food products mimic the taste and texture of meat bacon.

Unless otherwise specified, all percentages, parts and ratios as used herein refer to percentage, part, or ratio by weight of the total. Unless specifically set forth herein, the terms “a”, “an”, and “the” are not limited to one of such elements, but instead mean “at least one,” unless otherwise specified. The term “about” as used herein refers to the precise values as indicated as well as to values that are within statistical variations or measuring inaccuracies. In some embodiments, the term “about” refers to a range of 5% of a specified value. For example, the phrase “about 100” includes +/−5% of 100, or from 95 to 105.

The methods disclosed herein may be suitably practiced in the absence of any element, limitation, or step that is not specifically disclosed herein. Similarly, specific snack food embodiments described herein may be obtained in the absence of any component not specifically described herein. Thus, the crisps described herein may consist of those listed components as described above.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. For example, the range 1 to 10 also incorporates reference to all rational numbers within that range (i.e., 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

While this invention has been particularly shown and described with reference to several embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method of making seitan snack food products, said method comprising the steps of:
shaping a hydrated dough into a shaped dough, the hydrated dough comprising wheat gluten;
chilling the shaped dough, thereby forming a chilled dough;
boiling the shaped dough for between about 1 to about 2 hours, thereby forming a boiled dough maintaining said shape;
cooling the boiled dough at temperatures ranging from about 32° F. to about 40° F. for at least 1 hour;
reducing the size of the cooled dough into a plurality of portions;
frying the portions, thereby producing fried portions of less than about 2% moisture content;
adding a liquid flavoring solution to the fried portions to form flavored portions; and
drying the flavored portions to a water activity level of less than about 0.85.

2. The method of claim 1 wherein the hydrated dough comprises least about 25% wheat gluten, based on total weight of the dough.

3. The method of claim 1 wherein the hydrated dough further comprises barley.

4. The method of claim 2 wherein the hydrated dough further comprises a substantially equal amount of nutritional yeast and seasoning.

5. The method of claim 1 wherein the chilling step comprises chilling for at least about 30 minutes at a temperature of less than about 40° F.

6. The method of claim 1 wherein the boiling step comprises boiling at a temperature of between about 180° F. and about 215° F.

7. The method of claim 1 wherein the boiling step is performed in salted water.

8. The method of claim 1 wherein the cooling step comprises submerging the shaped dough in ice water.

9. The method of claim 1 wherein the cooling step comprises submerging the shaped dough into ice water for at least about 30 minutes, following by storing the shaped dough at refrigerated temperatures.

10. The method of claim 9 wherein the shaped dough is stored in refrigerated temperatures for at least 6 hours.

11. The method of claim 1 wherein the reducing step comprises cutting the shaped dough into a plurality of elongated slices.

12. The method of claim 1 wherein the frying step is performed at a temperature of between about 325° F. to about 375° F.

13. The method of claim 1 wherein said adding step comprises brushing, spraying, immersing, and any combination thereof.

14. The method of claim 1 wherein said drying step comprises dehydrating the flavored portions at temperatures of between about 200° F. to about 250° F.

15. A method of making seitan snack food products, said method comprising the steps of:
boiling a hydrated, shaped dough comprising wheat gluten to form a boiled dough;
reducing the size of the boiled dough;
frying the boiled dough, thereby forming a cooked seitan base of less than about 2% moisture content; and
drying the cooked seitan base to form a plurality of shelf-stable seitan snack food products with a water activity level of less than about 0.85.

16. The method of claim 15 wherein the dough of the boiling step comprises at least about 25% wheat gluten.

17. The method of claim 15 comprising the step of adding a liquid flavoring solution to the cooked seitan base prior to said drying step.

18. The method of claim 15 wherein the wheat gluten comprises at least about 70% protein.

19. The method of claim 15 wherein the shaped dough comprises a loaf shape.

20. The method of claim 19 wherein the reducing step comprises slicing the boiled dough into elongated slices.
